(19) United States
(12) Patent Application Publication
(10) Pub. No.: US 2013/0029098 A1
(43) Pub. Date: Jan. 31, 2013

(54) OPTICAL INTERFACE FOR REDUCED LOSS IN SPINEL WINDOWS

(71) Applicants: Jasbinder S. Sanghera, Ashburn, VA (US); Catalin M. Florea, Washington, DC (US); Guillermo R. Villalobos, Springfield, VA (US); Ishwar D. Aggarwal, Charlotte, NC (US); Bryan Sadowski, Falls Church, VA (US)

(72) Inventors: Jasbinder S. Sanghera, Ashburn, VA (US); Catalin M. Florea, Washington, DC (US); Guillermo R. Villalobos, Springfield, VA (US); Ishwar D. Aggarwal, Charlotte, NC (US); Bryan Sadowski, Falls Church, VA (US)

(21) Appl. No.: 13/559,936

(22) Filed: Jul. 27, 2012

Related U.S. Application Data
(60) Provisional application No. 61/512,081, filed on Jul. 27, 2011.

(51) Int. Cl. B29D 11/00; B32B 3/30

(52) U.S. Cl. 428/141; 216/24; 428/172

(57) ABSTRACT

A method for reducing transmission losses in a spinel-based optical element by building a structure on the surface of the optical element without the use of a previously prepared master. The structure can be built through reactive ion etching (RIE) of a pattern obtained through photolithography and liftoff, through RIE of a pattern through e-beam writing and liftoff, through RIE of a pattern using a self organized metal mask, or by direct hot-pressing the structure during fabrication of the optical element. Also disclosed is the related spinel-based optical element made by this method.

### CROSS-REFERENCE TO RELATED APPLICATIONS

This Application claims the benefit of U.S. Provisional Application 61/512,081 filed on Jul. 27, 2011, the entire contents of which are incorporated herein by reference.

### BACKGROUND OF THE INVENTION

1. Field of the Invention

The present invention relates generally to spinel ceramics and more specifically to reducing transmission loss in spinel ceramics.

2. Description of the Prior Art

In general an optical interface, such as the two facets of a window, a lens or an optical fiber will experience a certain amount of transmission loss, dependent on the refractive index of the constituent material. In particular spinel, MgAl₂O₄ as a transparent ceramic for example, exhibits an index of refraction in the 1.65-1.72 range, meaning a transmission loss of 6% to 7% per surface. These losses are referred in literature as Fresnel losses.

These losses can be reduced by applying anti-reflective coatings on the substrate, coatings that take advantage of the interference phenomenon that occurs in thin films. They can be designed to enhance the light transmission (reduce transmission loss) within a defined wavelength band (wherein constructive interference takes place), therefore reducing the reflection on optical interface. However, significant issues with this type of antireflective solution include poor adhesion and uniformity, delamination, poor resistance to external factors such as humidity, temperature, abrasion or simply they cannot withstand high intensity for the light intended to pass through the interface when used in a laser-based system.

A recent approach proposed to reduce the loss in transmission windows was to build a structure on the window surface in which the refractive index can be made to vary gradually from the air to the value of the window material. These structures are generally periodic in nature such as to generate strong diffraction or interference effects, and consist in a collection of identical objects such as graded cones or depressions. The distances between the objects and the dimensions of the objects themselves are to be smaller than the wavelength of light with which they are designed to interact. If these structures are periodic they are often referred to as “motheye” surface structures, otherwise they are called “random” surface structures. In general, the term of sub-wavelength surface (SWS) relief structure is also used. The term “motheye” is derived from the natural world; it was observed that the eye of a nocturnal insect (e.g., a moth) reflected little or no light regardless of the light wavelength or the angle at which incident light struck the eye surface. The artificially produced structures can then reduce significantly the transmission loss from an optical interface between air and a window or a refractive optical element. They are also shown to have higher resistance to damage from high-intensity laser illumination.

These surface structures can be patterned using holographic lithography or can be transferred to the surface by embossing or similar methods from a master prepared previously. SWS relief structures have already been proposed to be used to reduce the loss in semiconductor edge-emitting chips, to reduce reflection on wafer lids in micro-electromechanical systems (MEMS), and as chemical sensors or biological detectors. They have been demonstrated on a variety of substrates from sapphire and ALON to ZnSe to germanium.

There is only one known demonstration of antireflective structures in spinel transparent ceramics. Z. Sechrist et al., “Utilizing Imprint Lithography with a Tri-Layer Mask to Transfer Anti Reflection Moth Eye Structures into a Spinel Window,” 13^{th} EM WS (2010), the entire contents of which is incorporated herein by reference. The method uses imprint lithography, which requires the existence of a master and an intricate thin-film etching procedure.

### BRIEF SUMMARY OF THE INVENTION

The aforementioned problems are overcome in the present invention which provides a method for reducing transmission losses in a spinel-based optical element by building a structure on the surface of the optical element without the use of a previously prepared master. The structure can be built through reactive ion etching (RIE) of a pattern obtained through photolithography and liftoff, through RIE of a pattern through e-beam writing and liftoff, through RIE of a pattern using a self organized metal mask, or by direct hot-pressing the structure during fabrication of the optical element. Also disclosed is the related spinel-based optical element made by this method.

Since spinel is typically used in harsh environments that take advantage of the strength of the material, microstructuring the surface is one solution to reduce the transmission losses. According to one embodiment of the present invention, SWS relief structures are used on spinel windows, domes, lenses, and other optics to reduce the Fresnel losses in the 0.2-6.0 microns wavelength range. According to another embodiment of the present invention, several methods can be used to achieve the microstructure of the spinel surface: reactive ion etching of a pattern obtained through photolithography, reactive ion etching of a pattern obtained through self-patterning of thin metal films, direct-press of the pattern during the spinel optics fabrication, or any combination thereof.

The present invention provides a robust method of reducing the Fresnel losses in the case of spinel-based optics such as windows, domes and lenses. According to this method, the reduction in the reflectivity is obtained by structuring directly the material surface and hence it provides greater environmental stability. Also according to this method, the reduction in the reflectivity is obtained by structuring directly the material surface creating a graded-index interface which increases the surface resistance to damage from high-intensity laser illumination.

These and other features and advantages of the invention, as well as the invention itself, will become better understood by reference to the following detailed description, appended claims, and accompanying drawings.

### BRIEF DESCRIPTION OF THE DRAWINGS

FIG. 1 shows a motheye pattern etched in spinel with a photoresist mask (a) in a typical pattern and (b) the optical performance.

FIG. 2 shows the expected performance of a 1500-nm deep motheye structure on spinel. FIG. 2(a) is a transmission comparison between treated and untreated spinel. The graph in FIG. 2(b) shows the transmission increase between a bare surface and a surface with a motheye pattern.

FIG. 3 shows a demonstration of self-patterning of thin Au film on surface of spinel.

FIG. 4 shows the surface patterning of spinel by direct hot-pressing using a vitreous carbon (VC) stamp. FIG. 4(a) shows the pattern being reproduced from VC to spinel. FIG. 4(b) shows the optical performance of the patterned spinel window.

FIG. 5 shows the transmission of two spinel ceramic samples, each patterned on one surface only. The results demonstrate increasing transmission, approaching the theoretical value.

### DETAILED DESCRIPTION OF THE INVENTION

This invention pertains to a novel method for reducing the losses that occur at the interface between a spinel-based optical element and the ambient medium. In particular, this method allows reducing the reflection losses over the spectral transmission window of spinel and especially in the near-infrared and infrared region from 1 μm to 5 μm.

In one embodiment of the present invention, a motheye structure is built on the surface of spinel optics through reactive ion etching (RIE) of a pattern obtained through photolithography and liftoff. In another embodiment, a motheye structure is built on the surface of a spinel window through RIE of a pattern obtained through e-beam writing and liftoff.

An example is a motheye structure, having a periodic double-dimensional array of objects, such as but not limited to sloped holes, in which the geometry, dimensions and spacing of the holes are optimized to enhance the transmission, for example in the 2-5 μm region. This structure is obtained after patterning the spinel window using a photoresist film, such as but not limited to Shipley 1805, and a metal mask, such as but not limited to Cr, followed by etching of the pattern into the spinel substrate using an inductively-coupled plasma (ICP) RIE with a BCl₃-Cl₂ gas mixture.

In another embodiment, a random structure is built on the surface of spinel optics through RIE of a pattern using a self-organized metal mask. An example is a random structure having a quasi-periodic double-dimensional array of holes of various sizes and shapes, with the spacing of the holes optimized to enhance the transmission in a narrow band, for example around 0.6 microns. This structure is obtained after patterning the spinel optics with a self-organized thin film of gold and etching this pattern into the spinel substrate in an ICP-RIE using BCl₃-Cl₂ gas mixture.

In yet another embodiment, a motheye structure is built on the surface of the spinel optics by direct hot-pressing of the structure during the fabrication of the optics. An example is a motheye structure, having a periodic double-dimensional array of objects, such as but not limited to cones, in which the geometry, dimensions and the spacing of the cones are optimized to enhance the transmission, for example in the 2-5 μm region. This structure is obtained by patterning the surface of the pushing piston with the desired microstructure. The window to be pressed will therefore have the desired structure built in as it is made. Due to the high temperatures and pressures used for spinel fabrication, one material choice for the pressing piston is vitreous carbon, which can be patterned and etched in O₂-SF₆ mixture to create the inverse image of the desired motheye pattern.

### Example 1

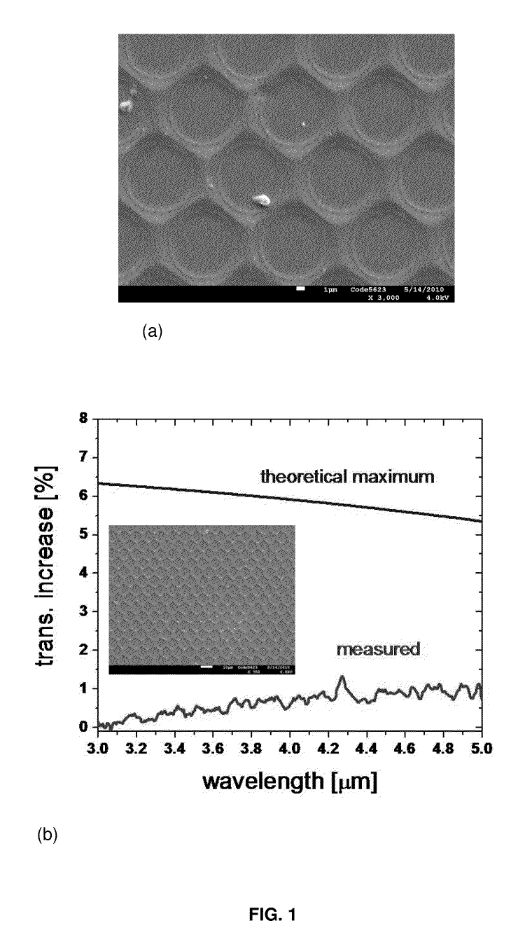

Preliminary trials of reactive ion etching of spinel were successful. Using an ICP-RIE tool, features 10 microns wide and 500 nm deep were etched in spinel windows. An example of an etched pattern and its optical performance are shown in FIG. 1. The Shipley 1818 photoresist was used as an etching mask.

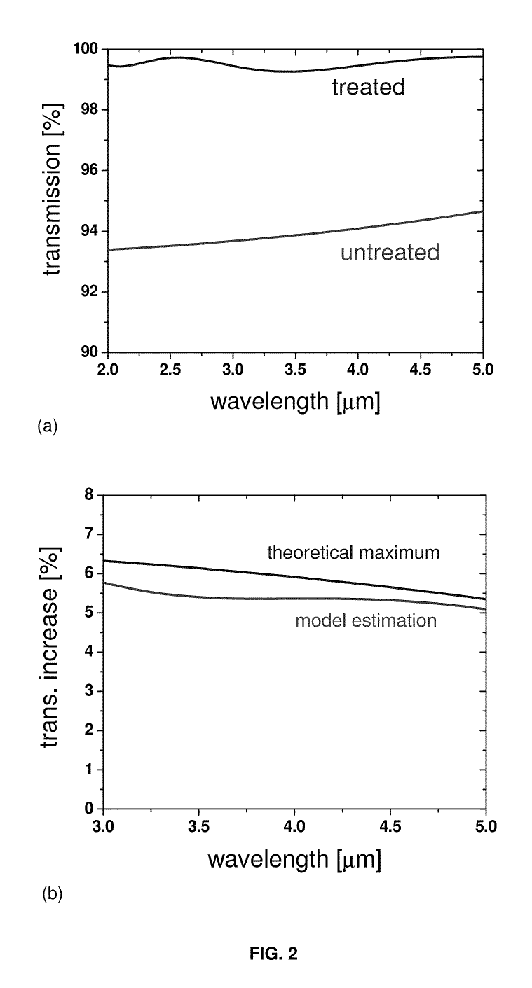

The mask used to create this pattern was not an optimized design for the 3-5 microns region but it nevertheless showed transmission enhancement. With proper design of the mask, larger transmission increase can be obtained in the wavelength range of interest. FIG. 2 illustrates the expected performance of a motheye pattern composed of circular holes periodically placed in two dimensions, with an equivalent period of 1.7 microns and a depth of the features of 1500 nm. As it can be seen, facet transmission can be increased from 94.5% to over 99.0% over the whole 2-5 microns range.

### Example 2

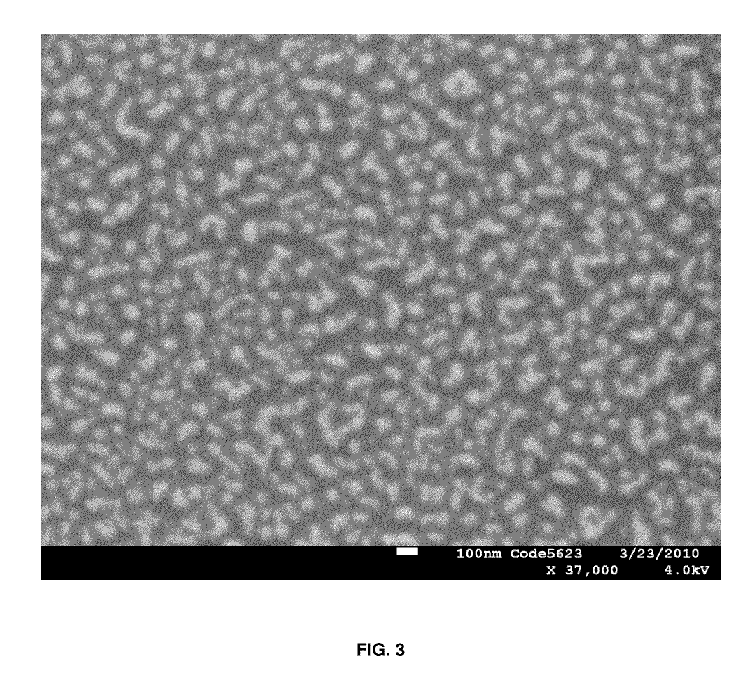

Self-patterning of thin metal films on the surface of spinel was demonstrated. A thin film of gold (5-10 nm) was thermally evaporated on the surface of the spinel optics and heated to 350° C. for 10 minutes. Nano-island formation was observed through gold coagulation, as illustrated in FIG. 3. The quasi-period of the nano-island distribution is in the 350-450 nm range. Etching of the spinel with this pattern should yield enhanced transmission at a wavelength of similar dimension.

### Example 3

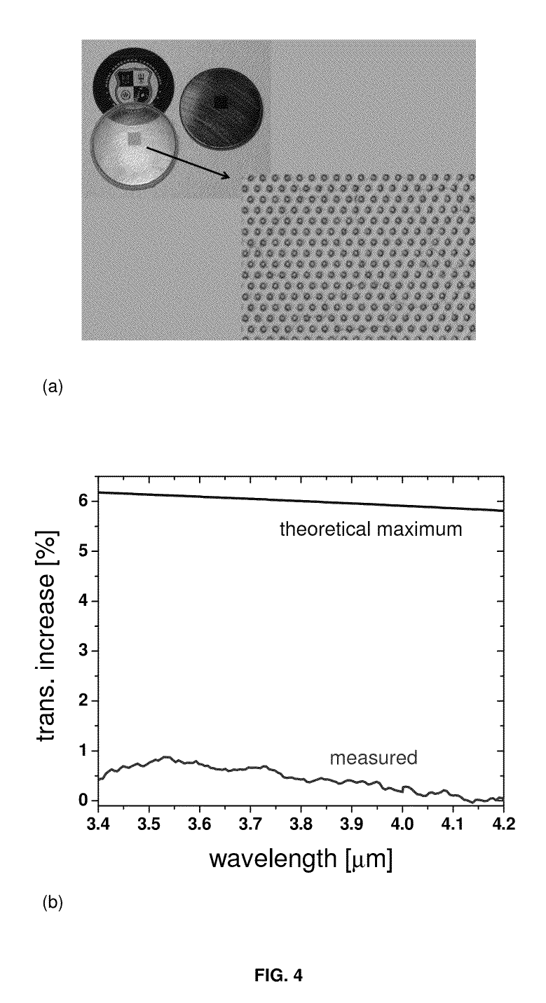

Preliminary trials were performed to demonstrate feasibility of patterning vitreous carbon (VC) and reproducing that pattern into the spinel optics interface during the fabrication of the spinel optics. Typical results are shown in FIG. 4. Features around 1-2 microns wide and 600 nm deep were successfully demonstrated.

### Example 4

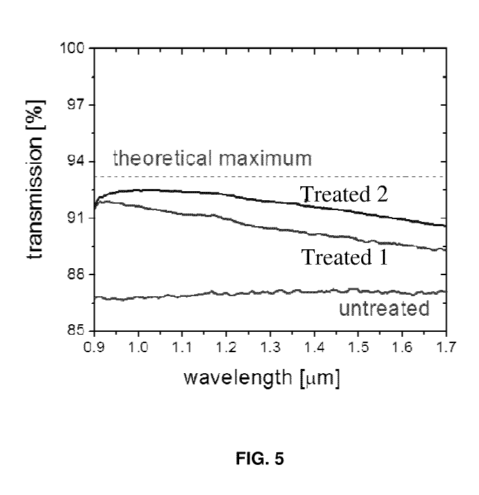

More trials of reactive ion etching of spinel were successful. Using an ICP-RIE tool, features <1 microns wide and ˜500 nm deep were etched in spinel windows. An example showing the improvements in the optical performance is shown in FIG. 5.

The above descriptions are those of the preferred embodiments of the invention. Various modifications and variations are possible in light of the above teachings without departing from the spirit and broader aspects of the invention. It is therefore to be understood that the claimed invention may be practiced otherwise than as specifically described. Any references to claim elements in the singular, for example, using the articles “a,” “an,” “the,” or “said,” are not to be construed as limiting the element to the singular.

What is claimed as new and desired to be protected by Letters Patent of the United States is:

1. A method for reducing transmission losses in a spinel-based optical element comprising:
building a structure on the surface of the spinel-based optical element,
wherein the structure is built without the use of a previously prepared master.

2. The method of claim 1, wherein the structure is built through reactive ion etching of a pattern obtained through photolithography and liftoff.

3. The method of claim 1, wherein the structure is built through reactive ion etching of a pattern through e-beam writing and liftoff.

4. The method of claim 1, wherein the structure is built through reactive ion etching of a pattern using a self-organized metal mask.

5. The method of claim 1, wherein the structure is built by direct hot-pressing the structure during fabrication of the optical element.

6. The method of claim 1, wherein the transmission losses are reduced in the 0.2 to 6.0 microns wavelength range.

7. The method of claim 1, wherein the transmission losses are reduced in the 1.0 to 5.0 microns wavelength range.

8. The method of claim 1, wherein the structure is a motheye surface structure.

9. The method of claim 1, wherein the structure is a random surface structure.

10. A spinel-based optical element made by the method comprising:
building a structure on the surface of the spinel-based optical element to reduce transmission losses,
wherein the structure is built without the use of a previously prepared master.

11. The optical element of claim 10, wherein the structure is built through reactive ion etching of a pattern obtained through photolithography and liftoff.

12. The optical element of claim 10, wherein the structure is built through reactive ion etching of a pattern through e-beam writing and liftoff.

13. The optical element of claim 10, wherein the structure is built through reactive ion etching of a pattern using a self-organized metal mask.

14. The optical element of claim 10, wherein the structure is built by direct hot-pressing the structure during fabrication of the optical element.

15. The optical element of claim 10, wherein the transmission losses are reduced in the 0.2 to 6.0 microns wavelength range.

16. The optical element of claim 10, wherein the transmission losses are reduced in the 1.0 to 5.0 microns wavelength range.

17. The optical element of claim 10, wherein the structure is a motheye surface structure.

18. The optical element of claim 10, wherein the structure is a random surface structure.
